(19) United States
(12) Patent Application Publication
(10) Pub. No.: US 2023/0018035 A1
(43) Pub. Date: Jan. 19, 2023

(54) CATION-EXCHANGE MEMBRANE WITH IMPROVED MONOVALENT SELECTIVITY, MANUFACTURING AND USES THEREOF IN ELECTRODIALYSIS

(71) Applicant: B.G. NEGEV TECHNOLOGIES AND APPLICATIONS LTD., AT BEN-GURION UNIVERSITY, Beer-Sheva (IL)

(72) Inventors: Oded NIR, Midreshet Ben-Gurion (IL); Eran EDRI, Moshav Avigdor (IL); Eyal WORMSER, Gedera (IL)

(21) Appl. No.: 17/781,880

(22) PCT Filed: Dec. 6, 2020
(86) PCT No.: PCT/IL2020/051257

§ 371 Date: Jun. 2, 2022

Related U.S. Application Data
(60) Provisional application No. 62/943,848, filed on Dec. 5, 2019.

(51) Int. Cl. B01D 69/14; B01D 61/46; B01D 69/12; B01D 71/68; B01D 71/02; B01D 67/00; B01D 69/02

(52) U.S. Cl. CPC B01D 69/148; B01D 61/46; B01D 69/12; B01D 71/68; B01D 71/025; B01D 67/0079; B01D 69/02; B01D 2325/42

(57) ABSTRACT

Disclosed herein a monovalent-ion-selective composite membrane comprising a polymeric cation exchange membrane and a metal-oxide-based layer, wherein said metal-oxide-based layer comprises a metal oxide or an organic-inorganic hybrid polymer, of e.g. Zn, Al, Mg, Si, Cu, W, Ni, or Ti. Also disclosed are the methods for the preparation of the membrane, and also electrodialysis assemblies comprising the membranes.

### BACKGROUND

In the last two decades, brackish groundwater emerged as an important water source for inland arid regions located at a distance from the sea. The current desalination technology, reverse-osmosis, utilizes pressure-driven membrane filtration to remove almost all dissolved species from the treated water, resulting in a low salinity permeate stream and a high salinity concentrate stream. The obtained concentrate poses a risk to the environment, due to its increased salinity, and therefore must be further treated, a fact that can substantially increase the cost of water production. Currently, concentrates from brackish water reverse osmosis (BWRO) plants are mainly left to evaporate in ponds, which occupy large areas and can leak to the environment.

Increasing the desalination recovery ratio, i.e. the percentage of desalinated water produced from the brackish feed, is one way to minimize the volume of concentrate solution produced in the process. Minimizing the concentrate's volume promotes a reduction in treatment costs and land footprint, while boosting water supply from this limited source.

However, the recovery ratio in BWRO is limited by the precipitation of sparingly soluble minerals, such as gypsum salts and silicates which may clog the membrane.

Another important aspect relating to desalination technology is that the removal of ions from the treated water source is carried out in a non-selective manner, including the removal of ions which considered to be vital for human health, such as Mg²⁺. Lack of Mg²⁺ in desalinated drinking water is estimated to negatively affect millions of people worldwide each year. It is even the requirement by some regulatory bodies to provide magnesium to the desalinated potable water. This problem may be addressed by utilizing electrodialysis having a monovalent selective cation exchange membrane (CEM), which can promote the selective removal of monovalent ions while retaining multivalent ions in the water source. However, the commercially available monovalent-selective membranes are often characterized by having high resistance and therefore these membranes are not widespread and this technology was not adopted for use in desalination processes.

Coating of membranes with inorganic layer has been disclosed, inter alia, in U.S. Pat. No. 5,968,326, disclosing deposition of Nasicon onto a cation-selective membrane, to improve various parameters thereof, including the efficiency. A variety of other methods have been disclosed to modify the surface of ion-exchange membranes to impart them monovalent-vs-polyvalent selectivity. For example, S. Abdu et al, ACS Appl. Mater Interfaces, 2014, 6, 1843-1854, deposited polyelectrolytes layers (layer by layer) on the cation exchange membrane, terminating with a positive polyelectrolyte. Earlier, T. Sata, J Polym Sci Polym Chem Ed, 1978, 16, 1063-1080, showed the effect of different polyelectrolytes, adsorbed to the membrane surface, on monovalent-vs-polyvalent selectivity. X. Pang et al, J. Memb. Sci., 2020, 595, 117544, modified the surface of a sulfonated polyphenyl sulfone membrane, forming a selective quaternized polianiline. S. Yang, et al, ACS Appl. Mater. Interfaces, 2019, 11, 17730-17741, deposited dopamine and crown ether on a cation exchange membrane for instilling specific selectivity for K⁺ transport. N. White et al, ACS Appl. Mater. Interfaces, 2015, 7, 6620-6628, deposited layers of polyelectrolyte on a Nafion membrane, achieving very high selectivity of K⁺/Mg²⁺. However, as in most of these cases, the higher selectivity is frequently accompanied by a high membrane resistance and energy consumption.

Thus, there is still a need in the art for a selective monovalent-ion-exchange membrane to allow a successful and efficient removal of monovalent ions while retaining and/or recovering essential multivalent minerals that are usually removed in the desalination process.

### SUMMARY OF THE INVENTION

In one aspect provided herein a monovalent-ion-selective composite membrane. The membrane comprises a polymeric cation exchange membrane and a metal-oxide-based layer thereon. The metal-oxide-based layer comprises a metal oxide or an organic-inorganic hybrid polymer, of a metal selected from the group consisting of Zn, Al, Mg, Si, Cu, W, Ni, and Ti. As demonstrated in the Examples section below, the layer possesses a positive charge in water at pH values relevant to water treatment by electrodialysis. The thickness of the metal oxide-based layer is usually between about 1 nm to about 100 nm, preferably between 10 and 30 nm.

The organic-inorganic hybrid polymer usually comprises the metal atoms interconnected via flexible units comprising two to ten carbon atoms and residues selected form the group consisting of diols, triols, primary diamines, secondary diamines, primary triamines, secondary triamines, dithiols, and trithiols. In the hybrid polymer these flexible units are chemically bound to the metal atoms, by the means of these groups, which are present in the polymer as residues of these groups. Preferably, the flexible units comprise ethylene glycol residues. Further preferably, the metal is aluminum. Preferably, the polymeric cation exchange membrane is a polysulfone-based membrane. In currently preferred embodiments, the metal-oxide-based layer is an ethylene-glycol-aluminum hybrid polymer (i.e. EG-Alucon).

In a further aspect provided herein a method for the preparation of a composite membrane comprising a metal-oxide-based layer and a polymeric cation exchange membrane, said method comprising the steps of: A) providing a polymeric cation exchange membrane in a suitable atomic layer deposition reaction chamber under inert atmosphere; B) alternatingly introducing b1) a metal precursor or b2) an oxidant into the chamber; C) purging the chamber to re-establish an inert atmosphere; and D) repeating steps B) and C) for predetermined number of cycles until a desired thickness is obtained. The steps of introducing b1) a metal precursor or b2) an oxidant into the chamber may be performed in this or reverse order, i.e. either first a metal precursor is introduced into the reactor, followed by C) purging, and then an oxidant is introduced into the reactor, followed by C) purging, or first an oxidant is introduced into the reactor, followed by C) purging, and then a metal precursor is introduced into the reactor, followed by C) purging.

The metal precursor utilized in step b1) may be selected from the group consisting of alkyl metals, metal alkoxides, metal halides, and alkyl amido metal compound. The oxidant utilized in step b2) may be selected from the group consisting of water, ethylene glycol, oxygen, hydrogen peroxide, a hydroquinone, a diol, a triol, a primary diamine, a primary triamine, a dithiol, and a trithiol. Preferably, the metal precursor utilized in step b1) is the alkyl metal which is trimethylaluminum. Preferably, the oxidant utilized in step b2) is ethylene glycol. The method may be performed for the predetermined number of cycles, which may usually be between 5 and 50.

In yet a further aspect, provided herein an electrodialysis assembly comprising a composite membrane as generally disclosed herein. The assembly may preferably be operated at a voltage conductively applied to the composite membrane, with the voltage producing a current density of between about 5 to about 500 Am⁻² in the membrane.

### SHORT DESCRIPTION OF THE DRAWINGS

FIG. 1a: schematically depicts Alucone deposition by MLD on a glass slide; FIG. 1b presents SEM micrographs of deposition of Alucone (left pane, labelled “Alucone”) and alumina (right pane, labelled “Al₂O₃”) on a cation exchange membrane. The sizing bar represents 10 μm distance, the captions “Al₂O₃ ‘platelets’”, “Exposed membrane”, “Cracks between the Al₂O₃ ‘Platelets’”, and “Buckling” represent Al₂O₃ platelets, exposed membrane areas, cracks between the platelets, and buckling of the platelets, respectively. Figure lc represents zeta potential (denoted as “ζ[mV]”) of glass substrate (denoted as “Glass (ozone cleaned)”), and the 100-layered alucone (denoted as “Alucone (X100, on glass)”) and 100-layered alumina (denoted as “Al2O3 (X100, on glass”) coatings on the glass substrate, as function of pH.

FIG. 2: Quartz crystal microbalance (QCM) measurement of mass gain (denoted as “Mass gain (ng/cm\hat{ }2”) during alucone molecular layer deposition process (MLD), as function of time (denoted “Time (sec)”). Labels “Eg” and “TMA” correspond to ethylene glycol and trimethyl aluminum, respectively. Inset: molecular structure of Alucone precursors (TMA and Eg), and alucone film growth; a stepwise growth process corresponding to the ALD reactant exposure is seen.

FIG. 3: Stability of the composite membrane of the invention having an Al₂O₃ layer as the metal-oxide layer, after soaking for 4 hours in various solutions.

FIG. 4a: AFM images of polymeric membrane (CEM) of untreated membrane. FIG. 4b: AFM images of polymeric membrane (CEM) coated with 50 cycles of EG-Aluc.

FIG. 5a: presents a photograph of MicroED cell by PCCell used for Eg-Aluc testing. FIG. 5b schematically demonstrates a stack arrangement of membranes and electrodes inside the cell. The label “Active layer (coating)” denotes the location of the coating on the cation exchange membrane (denoted “CEM”).

FIG. 6a: Comparison of treated, untreated and commercial mono-selective CEM performance. FIG. 6b: comparison of the membrane characterization before and after utilization.

FIG. 7: A further comparison of untreated, treated and commercial mono-selective CEM performance during and after the ED experiments. FIG. 7b: results for three consecutive 60 min electrodialysis sessions with the x25 alucone-coated CEM membrane, the selectivity over time.

FIG. 8: Selectivity vs energy penalty is demonstrated as the ratio between the calculated energy consumption using a membrane coated with the selective layer and an uncoated, non-selective one.

### DETAILED DESCRIPTION

The term “Alucone” and the term “Eg-alucone” or “EG-alucone” and the like, as appear herein and in the claims are used interchangeably and refer to a hybrid organic-inorganic polymer composed of monomers that contains aluminum and different carbon-based molecules, preferably ethylene glycol.

The term “cation exchange membrane (CEM)” as appears herein and in the claims refers to membranes that allow passage of cations through them, while preventing anions from passing; these membranes are usually composed of polymers containing fixed negative charges in their matrix, excluding co-ions (anions, which bear a negative charge) by an effect known as Donnan exclusion, while allowing counter-ions (cations) to pass through.

The term “atomic layer deposition” (ALD) or the term “molecular layer deposition” (MLD) as appears herein and in the claims refer to a method for deposition of thin films, in which a substrate is exposed sequentially to at least two precursors, one at a time, in the gas phase. The precursors (for example, A and B) react only one with each other and not with themselves (i.e., A molecules don't react with A, and B molecules don't react with B), meaning that each phase of the reaction is self-limiting, and can only proceed until full, uniform coverage with reactant A or B is achieved; exposure to the other reactant will then generate another layer, growing the film in a highly controllable fashion. In cases where such process is carried out utilizing metals or metal oxides as the reagent, the term ALD is used; when this process is carried out utilizing metal precursors and organic molecules as reactants (such in the case of Alucone for example), the term MLD is used.

As described above, a selective monovalent membrane for the efficient removal of monovalent ions from concentrates resulting from desalination processes can promote the overall recovery ratio of treated water and reduce the costs of such treatments. Thus, in one aspect, the present invention provides a monovalent ion selective composite membrane. The membrane comprises a base polymeric membrane and a metal-oxide-based layer disposed thereon. The metal-oxide-based layer may usually be physically adsorbed to the polymeric membrane, or may be covalently bound, e.g. via the metal atoms, to the membrane.

The metal-oxide-based layer comprises a metal oxide or an organic-inorganic hybrid polymer of a metal. The metal is usually selected from the group consisting of Zn, Al, Mg, Si, Cu, W, Ni, and Ti. The metal-oxide-based layer in the composite membrane as described above is characterized by having a metal oxide, or their corresponding organic-inorganic hybrid polymers (e.g. Alucone, Aluquinon etc.). The organic-inorganic hybrid polymer usually comprises the metal atoms interconnected via flexible organic units. These units are bonded to the metal atoms via functional groups, such as oxo, thio, and amino. In the hybrid polymer, these units are residues of molecules, such as diols, triols, primary diamines, primary triamines, dithiols, and trithiols, with the functional groups being reacted with a precursor of the metal, as generally described below. Particularly preferably, the flexible units comprise ethylene glycol residues. The flexible units may also comprise hydroquinone, methanol or ethanol amine derivatives or any other organic constituent with similar suitable properties. The hybrid polymer comprises a metal and at least one type of flexible organic units. When the metal is aluminum, and the flexible units are ethylene glycol residues, the hybrid polymer is called “EG-Alucone”. Similarly, when the metal is aluminum and the flexible units are a quinone derivative, the hybrid polymer may be termed “aluquinone”.

The metal in the metal-oxide-based layer may be selected based on the intended application and the chemical properties thereof. For example, when a chemical stability at lower pH range is required, e.g. between 4 and 7, the metal is selected such that its oxide is stable at this range, e.g. aluminum oxide. Thus, in some currently preferred embodiments, the metal used in the metal-oxide-based layer is aluminum. Preferably, the metal-based layer in the composite membrane as described above is characterized by having a metal oxide selected from the group consisting of Al₂O₃ and aluminum-based polymers. Other metals can be advantageously employed for other applications.

In the currently preferred embodiments, the metal-oxide-based layer is an ethylene-glycol-aluminum hybrid polymer (i.e. EG-Alucon).

The thickness of the metal-oxide-based layer is usually between about 1 nm to about 100 nm. Preferably, the metal-oxide-based layer of the composite membrane has a thickness between about 10 nm to about 30 nm.

The composite membrane of the invention may be characterized by having an absolute surface charge of between about 20 and 120 mV. The surface charge is provided by the metal-based-layer when hydrated at appropriate pH value. Preferably, the surface charge is a positive charge of between about +20 and about +120 mV.

The metal-oxide-based layer of the composite membrane of the invention may be characterized by having nanoscale pores. An average size of the pores may be between about 0.7 and about 10 nm. Preferably, the metal-oxide-based layer has pore size between about 4 and about 7 nm. Without being bound by a theory it is assumed that due to the relatively large pore size the membrane resistivity is low, and the selectivity imparted by the metal-based-layer is due to charge, as demonstrated in the examples below.

According to the principles of the invention, the composite membrane as described above is chemically stable and may be utilized several times.

In functional terms, the composite membrane is more permeable to monovalent cations than to polyvalent cations, e.g. divalent or trivalent cations. That is, when a potential difference is applied to a solution comprising mono- and polyvalent cations with the composite membrane according to the invention disposed between anode and cathode of the source providing the potential difference, the transport of monovalent cations is expected to be higher than that of divalent cations. This may be reflected in the selectivity of the membrane, i.e. the ratio of normalized concentrations difference of monovalent and divalent ions before and after the treatment; the exact formula to calculate membrane selectivity is presented in the examples section below. The selectivity of the composite membrane may usually be above 105%, e.g. above 110%, preferably above 115%, and may be as high as between 112% and 170%.

It has now been surprisingly found that a very high selectivity may not be necessary for certain applications, e.g. for the desalination of brackish water to potable standard. Brackish water varies in salinity and composition according to its source, giving advantage to tunable membranes that could have selectivity fitting specific requirements. As an example, the brackish groundwater of the Israel's Negev region contains approximately 1000 mg/L of Na⁺ and 100 mg/L of Mg²⁺. In addition, drinking water regulations and standards vary, with no clear worldwide standard for permitted or required concentrations of Na⁺ or Mg²⁺ are set by the world health organization (WHO). Most freshwater contains Na⁺ in concentrations of <20 mg/L, and water becomes noticeably salty in taste with Na⁺ concentrations above ˜200 mg/L. Water is a minor source of Na⁺ in terms of nutrition; diets is the main source of sodium. Overall, no single standard value could be chosen. In Israel, the Ministry of Health has considered adding magnesium to desalinated drinking water in concentrations of up to 20 mg/L. A reasonable target value for sodium may be below 100 ppm. Performing selectivity calculation, e.g. as described in greater detail below, based on target values of <100 mg/L sodium and >20 mg/L Mg²⁺, the cutoff selectivity value above 1.125 could be considered sufficient for transformation of brackish water to potable water by desalination, e.g. by electrodialysis. This value could be lower or higher given different initial and target concentrations, yet it is evident that a low selectivity could be even advantageous, as long as it is retained and does not fall to unity. As demonstrated in the appended examples, the cation-exchange membranes coated with 5 to 50 layers of EG-alucone readily give the requisite selectivity, which is retained to very high desalination ratios, e.g. over 70%.

According to the broadest principles of the invention, any polymeric membrane may be used in conjunction with the metal-oxide-based layer. The polymeric component may comprise flexible polymer chains, such as aliphatic repeating units, cyclic repeating units, aromatic repeating units, heteroaromatic repeating units and combinations thereof. However, preferably, the polymeric membrane is a cation exchange membrane. The cation exchange membrane may possess charged chemical groups within said membrane, the charged groups expressing negative charge at recommended operation conditions, e.g. sulfonic acid groups. Thus, preferably, the cation exchange membrane is a polysulfone-based membrane. In some embodiments, the polymeric membrane is an anion exchange membrane.

The polymeric membrane is usually a cation exchange membrane, and thus it may be characterized by an ion-exchange capacity. The ion-exchange capacity of the membranes suitable for the application as described herein is usually between about 0.5 to about 2 mEq/gr. The polymeric membrane usually has a thickness, which is a trade-off between mechanical properties and the diffusional and electric impedance. Usually, the polymeric membrane has a thickness of between about 10 to about 50 micrometers. Preferably, the membrane has a dense non-porous polymer structure.

In some embodiments, the metal-based layer of the composite of the invention is characterized by having a specific electric resistance of between about 0.001 and about 0.5 ohm*cm². In some related embodiments, the composite membrane of the invention is characterized by having a specific electric resistance of between about 0.5 and about 10 ohm*cm2.

As a further aspect, provided herein is a method for the preparation of the composite membrane as described above. The method is based on an atomic/molecular layer deposition methodology and includes several steps in which the different reactants are introduced into the reaction chamber. The chamber is usually kept under controlled sub-pressure and temperature. In the method of the invention, the substrate utilized is a polymeric membrane, and the desired metal oxide or a hybrid metal-organic polymer layer is deposited onto said membrane in a stepwise process. The sequences of deposition steps are termed cycles, and the number of cycles can be modified and tuned to match the chosen thickness of the metal oxide-based layer obtained on the polymeric membrane, comprising together—both polymeric layer and metal-oxide-based layer, the composite membrane of the invention.

Thus, the present invention provides a method for the preparation of a composite membrane comprising a metal oxide-based layer and a polymeric membrane, said method comprising the steps of: A) providing a polymeric cation exchange membrane in a suitable atomic layer deposition reaction chamber under inert atmosphere; B) alternatingly introducing b1) a metal precursor or b2) an oxidant into the chamber; C) purging the chamber to re-establish an inert atmosphere; and D) repeating steps B) and C) for predetermined number of cycles until a desired thickness is obtained. In some preferred embodiments, the cycle begins with a metal precursor, followed by an oxidant. However, the reverse order is also possible, i.e. the cycle starting with an oxidant (b2) and then introducing a metal precursor (b1).

In some embodiments the suitable ALD chamber is characterized in having a hot wall reactor with a uniform and turbulent flow of inert gasses.

In some related embodiments, the inert conditions utilized in the process are selected from argon saturated atmosphere or nitrogen saturated atmosphere. The polymeric membrane utilized in step (A) of the process of the invention may be any flexible polymeric membrane. The membrane may comprise a variety of flexible polymer chains, such as aliphatic repeating units, cyclic, aromatic repeating units, heteroaromatic repeating units and combinations thereof. Preferably, the polymeric membrane is a cation exchange membrane, as generally described above. The cation exchange membrane may have charged chemical groups e.g. sulfonic acid groups within said membrane.

The metal precursor utilized in step (b1) is a chemical moiety comprising the metal to be deposited, in an organometallic compound or metal halides. The metal is preferably selected from Zn, Al, Mg, Si, Cu, W, Ni, and Ti. The organometallic compounds may be selected from the group consisting of alkyl metals (e.g. trimethylaluminum, or diethylzinc), metal alkoxides (e.g. isopropyl aluminum, isopropyl titanium), metal halides (e.g. titanium tetrachloride), alkyl amido compounds (e.g. tris (dimethylamino) silane, tetrakis (dimethyl amido)titanium(IV)). In some currently preferred embodiments, the metal precursor utilized in step b1 is trimethylaluminum.

In some embodiments, the oxidant utilized in step (b2) is selected from the group consisting of water, ethylene glycol, oxygen, hydrogen peroxide, hydroquinones, diols or triols (e.g. glycerols), primary di or triamines (e.g. phenylene diamines) and di or tri thiols (e.g. ethylene dithiols). In some currently preferred embodiments, the oxidant utilized in step (b2) is selected from the group consisting of water and ethylene glycol. Preferably, the oxidant utilized in step (b2) is ethylene glycol.

Introducing of either the metal precursor b1) or of the oxidant b2) is usually performed by opening a respective valve of the feeding line of either the oxidant or the metal precursor. The sub-pressure subsisting in the reactor drives the reactants inside the reactor, and the amount of the reactant introduced is dependent on the temperature inside the reactor, on the temperature of the introduced reactant, and on the time the valves remain open. Preferably, the introducing of the metal precursor b1) occurs by allowing the metal precursor to enter the reactor for a time interval between 10 and 500 milliseconds. When the metal precursor is trimethyl aluminum, the time interval is preferably between 15 and 30 ms. The time for introducing the oxidant b2) may also vary dependent on the properties of the oxidant. For example, when the oxidant is water, the time may usually be between about 15 ms and about 30 ms. When the oxidant is ethylene glycol, time intervals of between about 750 ms to about 1100 ms may be needed. The time intervals may be readily determined, e.g. by a use of a microbalance in conjunction to the deposition chamber, which may promote and monitor an accurate and reproducible process, taking advantage of the layers mass accumulating with each step in the deposition cycle.

In some particularly preferred embodiments, the metal precursor utilized in the step b1) is trimethyl aluminum, and the oxidant utilized in the step b2) is ethylene glycol.

The purging according to step C) may be performed with any suitable inert gas, which does not react at the selected temperature with either the metal precursor utilized in the step b1), or with the oxidant, utilized in the step b2). The purging is performed after a deposition of either the metal precursor in step b1), or after the deposition of the oxidant in step b2). The currently preferable inert gas is argon.

The step D) is the repeated applications of the metal precursor and the oxidant, followed each by purging the reactor with an inert gas. Thus, one cycle comprises the application of b1) metal precursor, of b2) the oxidant, and two steps of purging.

The process usually comprises between 5 to 100 cycles. In some currently preferred embodiments, said process comprises between 5 to 50 cycles.

The deposition process is usually performed at a temperature of between about 30° C. to about 200° C. Preferably, as described in the appended examples, the process takes place at a temperature lower than the glass transition temperature of the membrane. Preferably, the deposition process temperature is at least 10° C. lower than the glass transition temperature of the membrane, more preferably at least 20° C. lower. The preferred range for the temperature are between about 30° C. to about 60° C., particularly when the membrane is cation exchange membrane PC™-SK, as described below. Alternatively, particularly when the membrane has a glass transition temperature of above 110° C. the process may be performed between about 50° C. to about 90° C.

It is postulated that applying a selective monovalent ion membrane to water concentrates can promote salvage of multivalent ions which are essential to human health, such as Mg²⁺. An electrodialysis process utilizing the composite membrane of the invention as described above and applying external voltage can assist with the removal of monovalent ions while retaining said essential multivalent ions in solution. Thus, the present invention further provides a method for a selective removal of monovalent ions from an aqueous solution comprising said ions, said method comprising the steps of providing a composite membrane as described above and contacting said membrane with an aqueous solution comprising monovalent ions sought to be removed, wherein said contacting is taking place under external voltage.

In some related embodiments, the method for monovalent ions removal is taking place from a solution comprising varied valency ions. According to the principles of the invention, said process promotes the selective passage of monovalent ions through the composite membrane of the invention while the membrane is not as permeable to multivalent ions as to the monovalent ions. In some embodiment, the current density applied in the method as described about is between about 5 to about 500 Am⁻². In some embodiments, the method is taking place at ambient temperature, or at a temperature of between about 5 to about 40° C. In some embodiments, the said removal is carried out under conditions known in the art for electrodialysis process.

In a further aspect, provided herein an electrodialysis assembly comprising a composite membrane as described above. The electrodialysis assembly as known in the art, may be adapted to utilize the composite cation exchange membrane according to the invention, disposed between two anion exchange membranes. The composite membrane is placed in the assembly such that the coating is facing the diluate stream, which is in electric communication to an anode of the power source, whereas the uncoated part of the membrane is facing the concentrate stream, which is in electric communication with the cathode of the electric source.

The assembly may be operated at a voltage conductively applied to the composite membrane. The voltage may produce current density of between about 5 to about 500 Am⁻² in said membrane.

### EXAMPLES

### Methods

### Atomic Layer Deposition

ALD was performed in a hot-wall ALD reactor (Arradiance GEMStar XT system, with a custom-made hollow cathode plasma source, and a quartz microbalance), under vacuum.

Aluminum oxide deposition has been performed at either 40° C. or at elevated temperature of 175° C. For 175° C. procedure, the process was performed using the following recipe, with the chamber evacuated to vacuum of ˜100 mTorr. While maintaining a continuous flow of Ar (99.999%, supplied by Maxima ltd, Israel) at a rate of 10 sccm, a short (21 msec) pulse of trimethyl aluminum (TMA; Strem Chemicals, USA) was introduced to the chamber. After 15 seconds of purging with Ar, a similar short pulse of water (deionized water with <5 ppm TOC and resistance of 18.2 Ω.cm) was introduced to the chamber followed by another 15 seconds of purging in Ar. This four-step sequence constituted a single ALD cycle, and was repeated as many times as needed to achieve the desired thickness. All precursors were at room temperature, but the tubes leading to the reaction chamber are heated to 115° C. (for TMA) and 130° C. (for H₂O). For 40° C. procedure, the vacuum was kept at —170 mTorr, with the 21 ms pulses of the reactants being purged for 60 s with Ar.

### Ellipsometry

Spectroscopic ellipsometry (fixed angle Woolam) was performed using Sentech SE800 Spectroscopic Ellipsometer equipped with a Xe-white light source, at an incident angle of 70°. Thickness of the oxide layer on the Si substrates was measured on uncoated substrates cleaned in the same batch. Refractive index for the alucone layer was assumed at a constant 1.5, based on A. Dameron, et al, Chem. Mater., 2008, 20, 3315-3326.

### Surface Potential

Surface potential measurements were performed using an Anton Paar SurPASS electrokinetic analyzer, equipped with an adjustable gap cell for measurement on hard substrates. Streaming potential measurements were conducted using 1 mM KCl solution, titrated by HCl and NaOH to the required pH for each measurement. For each streaming potential measurement, the pressure was ramped from 0 to 400 mbar and held for 180 s. Each measurement was repeated twice in each flow direction. As a reference, a polypropylene sheet was used on the other side of the flow channel. The reference sheet streaming potential was measured separately and subtracted from the results.

### X-Ray Photoelectron Spectroscopy

XPS measurements were performed for the deposited layer composition by using ESCALAB 250 XPS (Thermo Fisher Scientific). All photoelectric peaks binding energy were manually scaled by setting the binding energy of C1s C-H and C-C peak at 284.7 eV

### Substrate Preparation

Si wafers (100 orientation, B-doped, University Wafer, USA) and microscopic glass substrates, which were used for ellipsometry and surface-potential measurements, respectively, were cleaned for 1 h with a piranha solution (1:3 mixture of concentrated sulfuric acid and 33% wt hydrogen peroxide) and dried with a nitrogen stream prior to coating.

### Molecular Layer Deposition

MLD was performed at 65° C. using a similar protocol, with 1 s pulse of ethylene glycol (>99% pure, Bio Lab, Israel) preheated to 65° C. to increase its vapor pressure. To prevent condensation, the manifold lines were heated to 130° C. (EG/H₂O) or 115° C. (TMA). An in-situ quartz crystal microbalance (SQM-160, Inficon, Switzerland) was used to monitor the deposition process on 6 MHz Au-coated quartz crystals using Inficon SQM-160 monitor.

The membranes for deposition (PC™-SK, PCA-GmbH, Germany) were stored in 25% wt sodium chloride solution until use. Before deposition the membranes were washed with deionized water to remove excess salt, dried under a nitrogen stream (99.999% pure, Maxima, Israel), and left to dry completely, and then equilibrated for 10 min at the conditions inside the ALD reactor prior to deposition.

### Electron Microscopy

Scanning electron microscopy (SEM) was performed with a VERIOS XHR 460L, and samples were precoated with ˜5 nm Ir. Energy-dispersive X-ray spectroscopy (EDS) measurements were performed in the SEM by using an Oxford instrument X-MAXTM 80 detector, at an accelerating voltage of 5 keV and a probe current of 0.2 nA. Transmission electron microscopy (TEM) was performed using a Tecnai T12 TEM, and samples were pre-embedded in epoxy resin (Epoxy embedding medium kit, Sigma-Aldrich) and sliced to —100 nm thick slices in a microtome.

### FT-IR

FT-IR spectra were collected with a Thermo Scientific Nicolet iS50R spectrometer. A Ge-ATR with a 60° cut was used in a Pike Technologies Veemax III variable angle accessory. Membranes were soaked in ultrapure double deionized water (18.2 Qcm; <5 ppm TOC) during measurements and uniformly pressed against the ATR crystal with a constant force. The spectrometer and ATR accessory were continuously purged with 99.999% N₂ during measurements. A DTGS detector was used to collect and average 128 scans at a resolution of 4 cm⁻¹. Spectra were measured at 60° incident and reflection beam angles. Background spectrum was air.

### Differential Scanning Calorimetry

DSC was performed in a Mettler Toledo Star DSC operated under a N₂ flow of 80 mL/min and equipped with 70 μl alumina crucibles by heating the samples from 30° C. to 200° C., cooling back to 30° C., and heating again to 200° C., all at a rate of 10° C./min.

### Selectivity Calculations

The selectivity of the membrane was calculated according to the equation 1 below:

$${P}_{M {g}^{2 +}}^{N {a}^{+}} = \frac{( {C}_{N {a}_{0}^{d}} - {C}_{N {a}_{t}^{d}} ) / {C}_{N {a}_{0}^{d}}}{( {C}_{{Mg}_{0}^{d}} - {C}_{M {g}_{t}^{d}} ) / {C}_{M {g}_{0}^{d}}}$$

where Cₓ_{₀}_{^{d}} is the concentration of ion X in the diluate at the beginning of the experiment and Cₓ_{ₜ}_{^{d}} is its concentration at the specific sampling time. All selectivity values reported herein are an average of at least four fresh samples, and uncertainty values are the standard deviations of each set, with the exception of the cycling experiment, which was performed once and whose errors are based on the ICP measurement errors.

### Membrane Resistance

Membrane resistance was measured at 25° C. using a standard conductivity meter (El -Hamm a Instruments, Israel, TH-2300 conductivity/temperature meter; measuring frequency 800 Hz) in 0.1 M KCl, using a custom-made apparatus, based on the method and equipment described by Oren et al, J. Phys. Chem. B, 2008, 112, 9389-9399. Briefly, the apparatus included Platinum blackcoated Pt electrodes at both sides of a flow cell with fixed, known dimensions, such that the membrane was “sandwiched” in the middle of the cell. The cell conductivity was first measured without the membrane (with the solution flowing through the cell), which was then subtracted from the measurements of the membranes. The PC-SK membrane was dried under vacuum at 65° C. for 1 h (conditions similar to those used during coating, prior to the measurements), so as to negate the impact of these conditions on resistance and focus on the resistance added by the coating itself. Separate measurements were performed without drying so as to isolate the impact of drying. Each measurement was performed at least three times using different membrane samples, and the errors presented herein reflect the standard deviation between repetitions.

### Faradaic Efficiency

Faradaic efficiency (FE) was calculated for all ED experiments using the equation 2 below:

$$F E = \frac{\sum {X}_{i} {n}_{i} {Z}_{i}}{t * i / F}$$

The numerator represents the total number of mol-equivalents transferred: percentage transport for each cation (Xᵢ) times the number of moles of the species in the feed solution (nᵢ) and the valence Zᵢ of that species. The denominator shows the total number of electrons transferred through the system—with t being the desalination time, i the current, and F Faraday's constant (=96500 C/mol).

### Energy Consumption Calculations

Energy consumption calculations were performed to quantify the general savings on energy by using a lower-resistance membrane, based on those in H. Strathmann's “Assessment of Electrodialysis Water Desalination Process Costs”, in Proceedings of the International Conference on Desalination Costing, Lemassol, Cyprus, December 6-8, 2004, 2004, pp. 32-54. The specific energy cost for desalinating a unit volume product is proportional to the cell-pair area resistance, which can be expressed as per the equation 3 below:

$$R = \frac{Δ * ln ( \frac{{C}_{s}^{f d}}{{C}_{s}^{f c}} \frac{{C}_{s}^{c}}{{C}_{s}^{d}} )}{{Λ}_{s} ( {C}_{s}^{f d} - {C}_{s}^{d} )} + {r}^{a m} + {r}^{c m}$$

with R being the cell pair area resistance; A the cell thickness; Cₛ^{fd} and Cₛ^{fc} the equivalent concentrations at the feed for the diluate and concentrate, respectively; Cₛ^{d} and Cₛ^{c} the outlet concentrations of the diluate and concentrate, respectively; As the equivalent conductivity of the solution (which can be approximated as that of a solution within the operation salinity range without inducing great error); and r^{am} and r^{cm} the area resistances of the AEMs and CEMs, respectively.

With equal diluate and concentration volumes, i.e. with recovery ratio of 0.5, Cₛ^{c}=2Cₛ^{rd}-Cₛ^{d}, and Cₛ^{fc}=Cₛ^{fd}.Cₛ^{d} can be also be expressed in terms of desalination percentage, X, as Cₛ^{d}=(1-X)Cₛ^{fd}. As can be estimated for sodium chloride at 25° C. using the Debye-Htickel-Onsager equation to give: Λₛ=126.39−89.14\sqrt{C}.

Further, looking at ratios rather than calculating the energy cost in absolute terms as this allows giving generally useful information that is not bound to specific process-dependent factors, such as membrane areas, flow rates, number of cell pairs, etc. With the assumption of negligible energy requirements outside of ion transfer in the cell pairs (e.g. due to pumping, electrode reactions, etc.) and 0.5 recovery ratio, the ratio of energy consumption between processes using different

CEMs can be expressed as in the equation 4 below:

$$\frac{{E}_{1}}{{E}_{2}} = \frac{{r}^{s o l} + {r}^{a m} + {r}_{1}^{c m}}{{r}^{s o l} + {r}^{a m} + {r}_{2}^{c m}}$$

with r₁^{cm} and r₂^{cm} being the area resistances of the two CEMs compared, and r^{sol}, the resistance posed by the solution, being approximated as (equation 5)

$${r}^{s o l} = \frac{Δ * ln ( \frac{1 + X}{1 - X} )}{( 126.4 - 89.1 \sqrt{{C}_{s}^{f d}} ) ( X * {C}_{s}^{f d} )}$$

It can be seen that with fixed membrane resistance, the solution resistance decreases at high salinity. This means that the membrane resistance actually controls the relative energy consumption at high salinities of the solutions. For the calculations, desalination ratio of 90% was used, r^{am} was taken as a typical ion-exchange membrane resistance, 2.5 Ω*cm², the Δ as used herein was about 1 mm, and the salinity was for the salinity of brackish water as used herein, with Cₛ^{fd}=0.05 M, and also for seawater with Cₛ^{fd}=0.65 M and brine with Cₛ^{fd}=1.3 M.

### Example 1

### Alumina Layer Deposition on Glass and Silicon Substrates

In order to develop and characterize the deposited layer at temperatures suitable for atomic layer deposition (ALD) on the membranes, ALD was first performed on silicon (Si) and glass substrates. Growth per cycle was measured using ellipsometry on Si, surface potential was measured on a glass substrate and layer composition was quantified by XPS.

Analysis by spectroscopic ellipsometry (fixed angle Woolam) indicated a growth rate of 1.2 Å/cycle (9.9±0.1nm thickness after 84 cycles), roughly as expected for “ideal” Al₂O₃ ALD. Growth rate on Si in the presence and absence of a polymeric cation exchange membrane was measured at 40° C. The presence of the membrane in the reactor during the deposition gave rise to higher growth rates of 6.5 Å/cycle, compared to ˜1.5 Å/cycle without a membrane in the reactor. This is a result of soaking/infiltration and releasing of precursors in the membrane in each ALD cycle.

Surface potential as function of pH was measured for Al₂O₃ deposited on a glass substrate at 30° C. using 100 ALD cycles, as well as for the glass substrate itself. The results of the measurement showed that the Al₂O₃ layer had a positive surface potential at a pH up to the isoelectric point at ˜9.5. A repeated measurement using the same Al₂O₃ coated sample after titration from pH 5 to 10.5 produced similar surface potential values, demonstrating that the Al₂O₃ layer remained stable and unchanged during the measurement.

Layer composition. Glass substrates were coated with 50 ALD cycles at two conditions: A) at 175° C. using H₂O as an oxidant and B) at 40° C., also with H₂O. The deposited layer composition was investigated by using XPS (ESCALAB 250 Thermo Fisher Scientific). The lack of Si signal indicates that the measured signal is coming only from the deposited layer and not from the substrate on which said layer is deposited on. Peak deconvolution of the Al and O peaks was performed to quantify the amount of Al—O—Al found in Al₂O₃ lattice, or to Al—O—OH and Al—OH bonds found in Al(OH)₃. The O/Al atomic ratio was quantified as well, with Al₂O₃ expected to have a ratio of 1.5, AlO(OH) a ratio of 2, and Al(OH)₃ a ratio of 3. The obtained results depict that layers deposited at 175° C. result in Al/O ratio of 2.0, with 59% and 54% (accordingly) of Al in Al—O—Al bonds, while layers deposited at 40° C. demonstrate a ratio of 2.3 and only 35% of Al was in Al—O—Al bonds, a significant deviation from the common Al₂O₃ structure. The trend was slightly different when looking at 0 peak, with %0 in Al—O—Al bonds at 40° C. was similar. Tests performed on glass and silicon substrates enable analyzing the consequences of performing the reaction at a lowered temperature of 40° C. in terms of growth rate, layer composition and surface charge. The results showed that the reaction occurred at the desired temperature. Furthermore, the ellipsometry results showed that when no membrane was present in the reactor, the growth rate was 0.15 nm/cycle. However, XPS showed that the layer was far from being single phase Al₂O₃, and it contains Al—OH₃ and Al—O—OH. A layer deposited at 175° C. contained significantly less Al—OH₃ and Al—O—OH, suggesting that the low temperature causes incomplete surface reactions. The deposited layer had a positive surface charge, which remained unchanged during a repeated measurement, indicating the layer's stability. Finally, the layer deposition did occur and the desired positive surface charge was achieved, indicating that ALD process is applicable at this temperature.

### Example 2

### Deposition and Characterization of Alumina and Alucone Layers on Cation Exchange Membranes

Cation exchange membrane PC™-SK was subjected to DSC measurements to define the glass transition point, as a limiting factor for the deposition processes. The glass transition point was found at about 85° C., therefore the processes were performed at temperatures below 80° C.

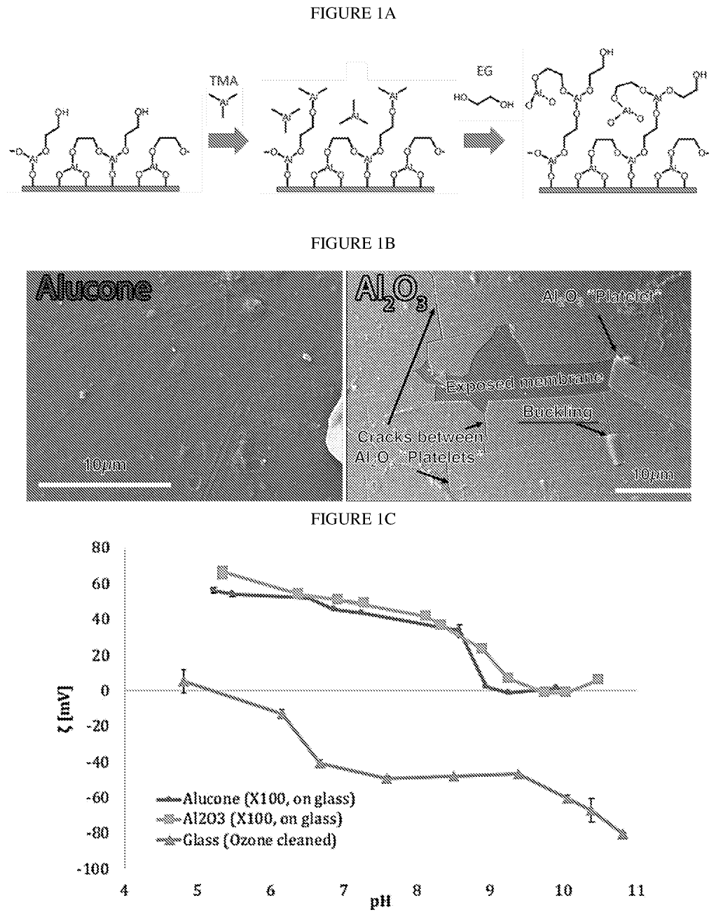

An Al₂O₃ layers deposited at 40° C. on the cation exchange membrane (CEM) PC™-SK as described above. The process and the results are schematically demonstrated in the FIG. 1. The FIG. 1A schematically represents the deposition process on the glass slide, including the steps of TMA addition and ethylene glycol addition to provide an alucone layer. The FIG. 1B is top view SEM images of alucone on the left and Al₂O₃ on the right deposited on polymeric membrane which is a cation exchange membrane. FIG. 1C demonstrates zeta potential of Alucone and Alumina deposited on glass slide, as a function of pH.

SEM micrographs of as deposited Al₂O₃ layers on CEM membrane showed ALD growth at ˜6 Å/cycle. After 25 ALD cycles a “bumpy” growth was visible, suggesting an island-growth mechanism — nucleation from specific sites on the membrane surface rather than homogenous layer-by-layer growth. The coated membrane was then put in deionized water for 1-2 hours, the water was blotted off and the membrane dried in air. SEM micrographs of the dried coated membrane showed cracks in the top layer (Al₂O₃) that split the deposited layer into platelets, which in a few cases peeled-off the surface, as seen in the FIG. 1B, right pane. SEM-EDS results depicted that the Al₂O₃ layer is deposited on the membrane in a linear proportion to the number of ALD cycles, as desired, and in agreement with ellipsometry results. Peeling is attributed to possible lack of covalent attachment to the membrane, supported with an island growth mechanism that indicate poor wetting and chemical bonding of the Al₂O₃ layer to the membrane, as well as by the large mechanical stresses introduced to the membrane-coating interface by swelling of the membrane when wetted and by bending the flexible membrane, whereas the coating, made of a rigid ceramic compound, does not swell and has very low flexibility, preventing efficient dissipation of the stress.

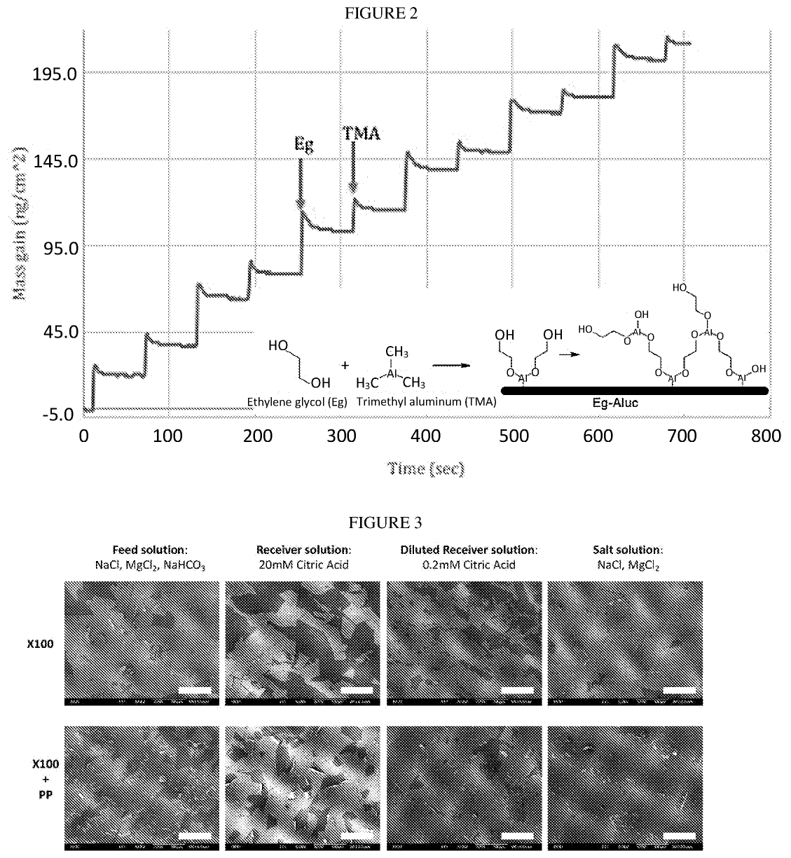

Ethylene glycol alucone (EG-Alucone) layer was deposited by conjugation of ethylene glycol (EG) in with trimethyl aluminum (TMA), similarly to the depicted in FIG. 1A. EG was used as oxidant instead of water, as described in Example 1 in the molecular the layer deposition (MLD) process. The process was carried at 65° C. under a continuous flow of argon (10 sccm). EG was heated to 65° C., while the TMA was kept at RT. As described above, a single cycle of MLD included a short (21 msec) pulse of TMA, followed by 60 seconds of purging with argon, then a second pulse of EG, followed by further 60 seconds of purging. Using a built-in Quartz crystal microbalance (QCM), a step wise deposition growth was found, with a TMA step weight increase of 11±1 ng/ cm² and EG step of 22±4 ng/ cm². The calculated EG-alucone growth rate on a cation exchange membrane was found to be of ˜12-15 Å/cycle (based on TEM cross-section), which is larger than the growth rate on hard substrates (˜1.5 Å/cycle, based on elipsometry). FIG. 2 demonstrates the deposition of the layers.

This growth rate is significantly higher than the growth rate that was obtained here for alucone on hard and impermeable substrates; and also higher than the expected growth rate for a fully extended ethylene glycol molecule in a single MLD cycle. The deviation from an ideal MLD growth mode was also evident from an enhanced growth rate (3.8±0.3 Å/cycle) over a spectating Si wafer put together in the coating chamber with the membrane during MLD. Nonetheless, EDS measurements of the alucone-coated CEMs indicate that, in the range tested, the amount of Al increased linearly with the number of cycles in both Al₂O₃ ALD and alucone MLD.

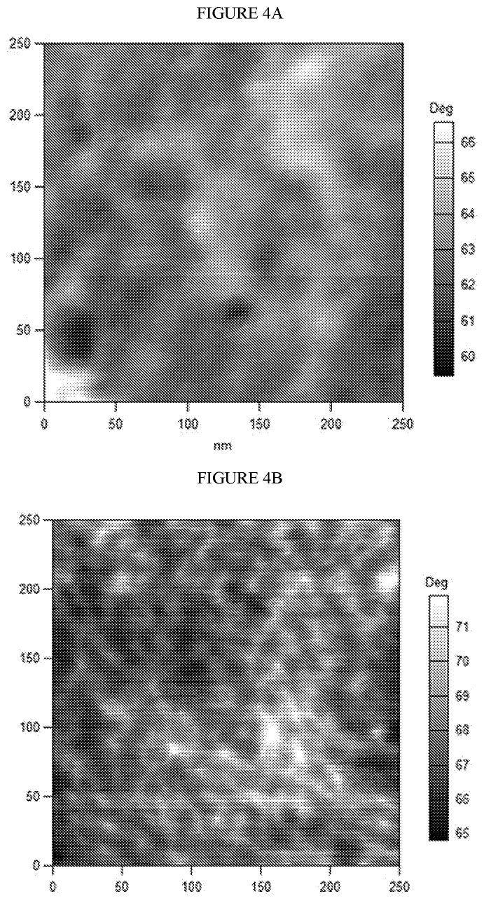

AFM analysis (FIGS. 4A-4B) shows that the pristine CEM membrane has a nanoscale structure, which can be described as continuous with two types of apparent features: one type is few nanometers in diameter, and the other 20-50 nm in diameter. This structure is superimposed on a web-like surface structure with threads that can reach a length of a few micrometers and a width of 0.4-0.5 μm. These webs seem to swell when hydrated. In contrast to the untreated CEMs, the CEMs coated with 50 cycles of EG-alucone (corresponding to a nominal thickness of ˜30 nm) has a surface structure composed of a more uniformly sized features in the range of 10-15 nm. Some of the larger features (20-50 nm) are still apparent, but the smaller features of only few nanometers have disappeared. The larger scale web-like structure is still apparent after coating with EG-alucone coating.

### Example 3

### Test Membranes Functionality

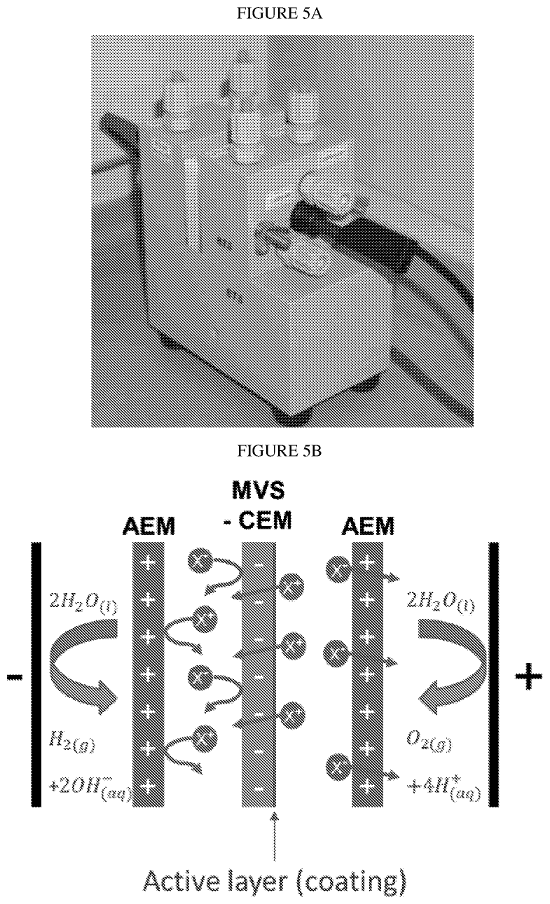

An Al₂O₃ layer was deposited on a cation exchange membrane as described above. Electrodialysis ion-transport experiments were performed in order to determine selectivity between ions of sodium (Na^{t}) and magnesium (Mg²⁺), by MicroED cell (PCCell™). The MicroED cell by PCCell™ used for Eg-Aluc testing is demonstrated in the FIG. 5A. A membrane of ca. 3 cm in diameter was placed between two chambers, one containing 40 mL of feed solution containing 1000 ppm Na⁺ (as NaCl and NaHCO₃⁻ to limit pH changes) and 100 ppm Mg²⁺ (as MgCl₂), and the other with 40 mL of 0.25 mM citric acid. The feed solution composition is similar to what is found in brackish water in Israel Negev region. Pt electrodes were placed 1 cm away from the membrane in each compartment, a magnetic stirrer was placed in each compartment and a constant voltage of 3V was applied to transfer cations from the feed compartment towards the cathode in the receiver compartment, as schematically shown in the FIG. 5B. Samples were taken periodically during 100 minutes experiments and their composition was analyzed by ICP-OES (Varian Agilent 700) to enable calculation of selectivity during and at the end of the experiment. A pristine and a modified membranes of the invention were tested several times, as well as a commercially available monovalent selective cation exchange membrane (CEM). The results of CEMs coated with Al₂O₃ were not reproducible. The irreproducibility is partly assigned to the peeling mechanism described above. The scanning electronic micrographs are presented in the FIG. 3, demonstrating the effect. The membranes were subjected to soaking for 4 hours in various solutions used in the experiment. Coating cracking and peeling was observed in all cases, whereas the degradation was faster in citric acid solutions.

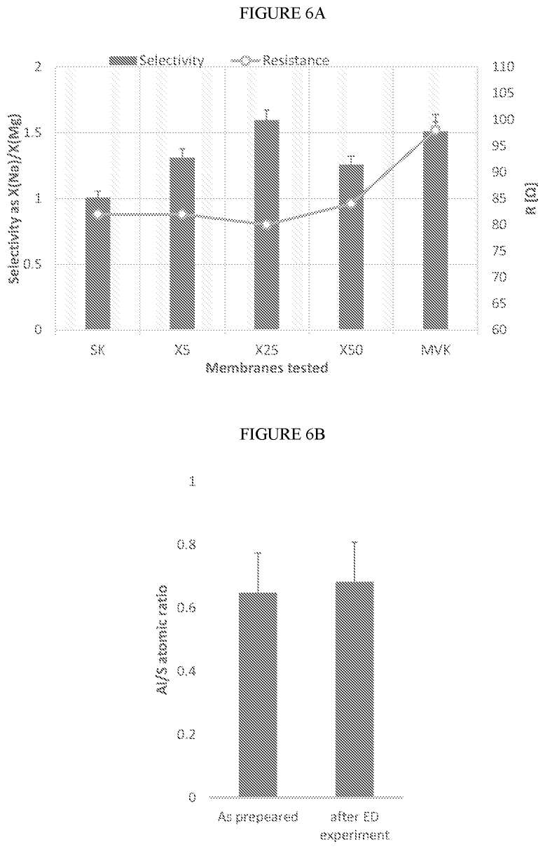

Alucone layers on cation exchange membrane were deposited as described above. The selectivity and stability of the Eg-Aluc CEM were tested the results are shown in FIGS. 6a and 6b. FIG. 6a demonstrates the selectivity by diluate concentrations after 60 minutes of electrodialysis (ED). The left axis, denoted as “Selectivity as X(Na)/X(Mg)”, represents selectivity values as ratio between sodium and magnesium concentrations. The bars represent selectivity values (denoted as a legend label “Selectivity”), and the line represents resistance (denoted as a legend label “Resistance”). Resistance in Ohms is shown in the right vertical axis, denoted as “R [Ω]”. FIG. 6b demonstrates the ion current resistance (at 50 mA). SK- a pristine, un-treated CEM; no selectivity of Na over Mg (S=1) is observed. X5; X25; X50—a CEM coated with 5, 25 or 50 layers of alucone; an increase in selectivity is observed of up to 150% with respect to untreated CEM. MVK—a commercial mono-selective CEM (PC™-MVK) showing similar selectivity as treated non-monoselective CEM with 25 layers of alucone. Despite the increase in selectivity in the Eg-Aluc CEM, the membrane resistance did not increased significantly, which would result in energy savings. Selectivity was measured after 60 minutes of ED, starting with 1000 ppm of Na⁺ and 100 ppm Mg²⁺.

The selectivity was measured with initial dilute and concentrated compartment concentrations of 100 ppm Mg²⁺ (as MgSO₄) and 1000 ppm Na⁺ (as Na₂SO₄), respectively, with 50 mL solution in each compartment, and 200 mL of 0.25M Na₂SO₄ as electrode solution. A single cell-pair was used in the configuration of the tested membrane, with the treated (selective) side facing the anode, being placed between two PC-SA standard AEMs in a PCCell-GmbH micro-ED electrodialyser with a Pt/Ir-coated titanium anode and a V4A steel cathode. The diluate and concentrate were circulated at 8.5 mL/min from a 50 mL batch. One 200 mL batch of a 0.25 M di-sodium sulfate solution was used for both the cathode and anode, flowed at 50 mL/min, and constantly mixed back into the batch to negate pH changes due to the electrode reactions. Experiments were run at a constant current of 50 mA (i.e. current density of 2.5 mA/cm²), applied using a Lion LE 305D DC laboratory power supplier, for 60 minutes, and reached desalination of about 70%. Samples (0.5 ml were taken periodically (30 mins), diluted by a factor of 20 and analyzed using inductively coupled plasma—optical emission spectrometry ICP-OES (Spectro, Spectro Arcoss, Germany). Comparison was made between a pristine un-treated CEM (SK), and the CEM coated with 5, 25 or 50 layers of alucone (denoted as x5; x25; x50), and a commercial mono-selective CEM (PC™-MKV).

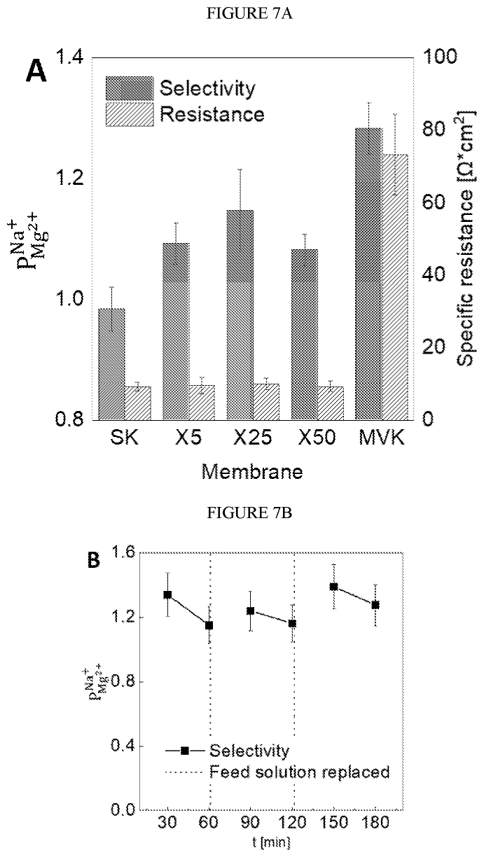

It can be seen in the FIG. 6A that the selectivity of CEM with 25 nominal molecular layers of EG-Aluc, corresponding to ˜15 nm, was up to 150% higher than untreated membrane (Sx25=1.5; SK=1), which is comparable to commercial mono-selective membranes (MVK) for electrodialysis. Moreover, the EG-Aluc-CEM is 15-˜86% less resistant to ion transport than the commercial mono-selective membrane as seen in FIG. 7.

Under conditions when the respective depositions of x5, x25 and x50 layers gave thickness roughly of 2, 10 and 20 nm, the selectivity of the membranes was slightly lower, namely, 1.09±0.03, 1.15±0.07, and 1.08±0.03. Even under these conditions, the value of 1.15 is still over the selectivity threshold required to retain sufficient amount of divalent ions in potable water, without the need to add the divalent salts after the AD process. It is noteworthy, that under similar conditions, i.e. after a 60-minute ED to about 70% desalination, the commercial monovalent ions selective membrane PC™-MVK has shown selectivity of 1.28±0.04.

### Example 4

### Membrane Characterization

The membranes' resistance was measured. The measured resistance was similar in uncoated PC™-SK CEMs (9 ±1 Ω.cm²) and MLD-coated CEMs (10±2 Ω.cm², 10±2 Ω.cm², and 9±1 Ω.cm² for membranes after 5, 25, and 50 MLD cycles, respectively), indicating that the coating did not considerably increase the transport resistance of the monovalent ions through the membrane. In contrast, the specific resistance of commercially available PC™-MVK monovalent-selective CEMs was 73±11 Ω.cm², which is 7-fold higher than that of the MLD-coated PC™-SK CEMs. The specific resistance of as bought PC™-SK membranes (i.e., membranes that had not been dried for MLD-coating) was 2.6±1.0 Ω.cm², which is in agreement with the membrane specifications (˜2.5 Ω.cm²), which indicates that some structural changes may occur during the drying-rewetting process or when heating to 65° C. in a vacuum.

The surface charge was determined by streaming potential method as described above. The membranes had a positive potential between +30 and +60 mV, at pH range between 5.5 and 8.5.

XPS results of as-prepared alucone-coated CEMs indicate that the O/Al atomic ratio was 2.1. The ideal ratio for alumina is 1.5, and for alucone is 3. No sulfur peak, which was observed in the uncoated membrane due to the sulfonate groups present in it, was observed in the coated membranes, indicating that the coating thickness produced by 50 MLD cycles was sufficient to suppress signal from the membrane. Following a 2-h exposure to water, the O/Al ratio increased to 2.4 and slight shifts were observed in the Al2p and O1s binding energy peaks. This deviation from the expected stoichiometry could stem from the existence of unreacted methyl groups and Al₂O₃-like regions, arising from hydrolysis and rearrangement of the structure in ambient air or water. The Cl1s peak of an as prepared PC™-SK membrane coated with 50 cycles of alucone shows binding energies corresponding to C—C and C—H bonds (˜285 eV), and C—O bonds (a shoulder at 286.1 eV). After soaking the membrane in water for 2 h, an increase in intensity of the 285 eV peak alongside the emergence of a new peak at ˜288.7 eV were observed. Additionally, small shifts of Al2p and O1s peaks to higher binding energies (0.4 an 0.2 eV, respectively) were present, which could be attributed to a decrease in hydroxide and oxyhydroxide species content (e.g., AlO(OH)₂ or Al(OH)₃).

ATR-FT-IR showed several bands in the modified membrane that are not apparent in the pristine membrane. These bands are centered around ˜1598 cm⁻' and ˜850 cm⁻¹. The former is attributed to vinyl ether groups, while the latter is a convolution of several bands, including vinyl ether asymmetric vibration and Al—O vibration. Additionally, a small shift in the ˜1250 cm⁻¹ band was observed and no indication of C═O groups (at 1700-1750 cm⁻¹). These results indicate the formation of vinyl ether functional groups, such as CH2═CH—O—Al in the alucone layer, which is accompanied by a dehydration reaction. Besides, no direct evidence for a reaction of the MLD precursors with the membrane was found.

To determine the iso-electric point of the deposited layer, streaming potential measurements were conducted on a glass substrate coated with 100 cycles of alumina or alucone. It has now been surprisingly found that a positive surface potential could be present in alucone, which is important for a coating to serve as a selective layer based on coulombic repulsion. The IEP of both alucone and alumina layers was 9-9.5, which is significantly higher than the approximately neutral pH in typical brackish water desalinated for drinking or agriculture. Therefore, the layer is expected to have a positive surface charge under standard operating conditions.

To verify that a charge-based exclusion mechanism indeed caused the observed selectivity in a uniformly coated membrane, ED was performed with the x25 membrane at pH ˜9.5, which is slightly above the IEP of the alucone layer. For this experiment, the pH of the feed water was increased prior to ED by adding 0.1M NaOH. Then, it was monitored and kept constant in the diluate compartment by manually adding 50 μL 0.1M NaOH whenever the pH dropped by at least 0.25 pH units below the desired pH; the volume added to the solution and the Na⁺ concentration added to the feed were negligible (<1%). At this pH, the selectivity of the coated membrane was similar to that of the uncoated membrane, corroborating that the selectivity is induced by the positively charged alucone layer and disappears when the coating loses its positive surface charge at the IEP.

High-resolution SEM was used to examine the morphology of the deposited layer. Alucone was not uniformly deposited on the PC™-SK surface; rather, initially, some sections were coated with continuous layers, while round, 20-30 nm sunken regions (dimples') appeared to be uncoated. The absence of Al in these dimples and its presence in the surrounding regions were confirmed by a SEM-EDS elemental mapping. Additionally, while dimples in the surface were discernable after a single MLD cycle, they were not observed in the pristine PC™-SK membrane, indicating that they resulted from the MLD process, rather than from the drying and loading in a high vacuum. Adding more alucone layers resulted in the formation of ‘alucone domes’ over the dimples, namely, alucone coating over the dimples, and these domes appeared to close after ˜25 cycles of alucone deposition. Additional coating layers seemed to uniformly thicken the alucone dome layer, while the dimpled areas mostly disappeared and the membrane surface appeared to be smooth. At a higher coating thickness, the coating was more prone to cracking (but not peeling), and some were observed, especially when the membrane was folded or handled roughly.

### Example 5

### Membrane Stability

The EG-Aluc-CEM was found stable during the ED process, and it retained its selectivity in at least five sequential ED experiments with fresh solutions. To test the stability of the modified EG-Aluc-PC-SK membrane, several consecutive 60 min desalination experiments were conducted, using the same membrane for all experiments but refreshing the feed with fresh solutions. The operational performance (voltage and current) remained stable and the selectivity recovered after refreshing the feed solution. This result demonstrates the stability of the coated membrane under the tested operational conditions.

Further data are presented in the FIG. 7A. In the Figure, monovalent selectivity and specific resistance of CEMs is demonstrated. Main (left) axis presents selectivity after 60 min of electrodialysis, using the uncoated PC™-SK membrane, PC-SK membranes coated with 5, 25, or 50 cycles of alucone MLD, and a commercial monovalent-selective PC™-MVK membrane. Secondary (right) axis presents specific membrane resistance in 0.1 M KCl The resistance shown for the uncoated SK membrane was measured after drying in the same conditions as those of the coated membranes. The values and error bars indicate the average and standard deviations of four experiments with each membrane. In the FIG. 7B, results for three consecutive 60 min electrodialysis sessions with the x25 alucone-coated CEM membrane, showing a stable performance over time. The decrease in selectivity during each single desalination experiment is due to the greater depletion of Na⁺ compared to Mg²⁺ with the selective membranes, leading to a change in their ratio in the solution and, therefore, to lower Na⁺ availability and thus the increased Mg²⁺ transfer. Error bars are based on estimated uncertainty in concentration determination by ICP-OES.

### Example 6

### Comparison of Energy Efficiency with known ED Membranes

As described in details above, it is possible to estimate the relative increase in energy consumption ratio, which can be determined regardless of process scale and without a need for considering many technical details of the specific process, such as membrane areas, number of cell pairs etc.

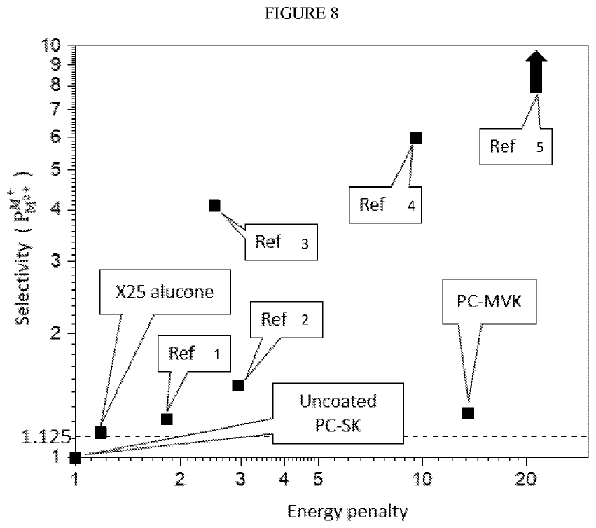

Therefore, the x25 membrane specific resistance of 10 Ω.cm², was compared to the commercial membrane PC™-MVK with specific resistance of 73 S2cm², both prepared by coating the same base (non-selective) membrane (PC™-SK). Utilizing the x25 membrane according to the invention allows decreasing by a factor of five the energy consumption for selective desalination. Additionally, comparing the energy penalty of other selective CEM known in the art resulting from the added resistance of the monovalent selective layers to the x25 membrane, it was found that the previously reported monovalent selective layers impose an energy penalty that is between 65% and 2030% (!) higher than the that imposed by the disclosed alucone coating. The results are summarized in the FIG. 8. Selectivity vs energy penalty is demonstrated as the ratio between the calculated energy consumption using a membrane coated with the selective layer and an uncoated, non-selective one. The dashed line shows the required selectivity value calculated for brackish water desalination, as disclosed above. The x25 alucone membrane has the lowest energy penalty found in the literature for an MVS-CEM, while satisfying the required selectivity. The references are: #1 is S. Abdu et al, ACS Appl. Mater Interfaces, 2014, 6, 1843-1854, #2 is T. Sata, J Polym Sci Polym Chem Ed, 1978, 16, 1063-1080, #3 is X. Pang et al, J. Memb. Sci., 2020, 595, 117544, #4 is S. Yang, et al, ACS Appl. Mater. Interfaces, 2019, 11, 17730-17741, and #5 is N. White et al, ACS Appl. Mater. Interfaces, 2015, 7, 6620-6628. The references are discussed briefly above.

These results convincingly demonstrate that the membranes as disclosed herein are the most energy efficient from those that are available today. Even the tested membranes with modest selectivity of about 1.15 (at the end of the process) is actually enough to provide potable water with required amounts of divalent cations, and the selectivity achieved can be as high as about 1.6 for alucone-coated membranes, and possibly even higher, providing extraordinary efficiency.

1. A monovalent-ion-selective composite membrane comprising a polymeric cation exchange membrane and a metal-oxide-based layer, wherein said metal-oxide-based layer comprises a metal oxide or an organic-inorganic hybrid polymer, of a metal selected from the group consisting of Zn, Al, Mg, Si, Cu, W, Ni, and Ti.

2. The composite membrane according to claim 1, wherein the thickness of said metal oxide-based layer is between about 1 nm to about 100 nm.

3. The composite membrane according to claim 1, wherein said organic-inorganic hybrid polymer comprises the metal atoms interconnected via flexible units comprising two to ten carbon atoms and residues selected form the group consisting of diols, triols, primary diamines, secondary diamines, primary triamines, secondary triamines, dithiols, and trithiols.

4. The composite membrane according to claim 3, wherein said flexible units comprise ethylene glycol residues.

5. The composite membrane according to claim 1, wherein said polymeric cation exchange membrane is a polysulfone-based membrane.

6. The composite membrane according to claim 1, wherein metal is aluminium.

7. The composite membrane according to claim 1, wherein said metal-oxide-based layer is an ethylene-glycol-aluminium hybrid polymer (i.e. EG-Alucon).

8. A method for the preparation of a composite membrane comprising a metal-oxide-based layer and a polymeric cation exchange membrane, said method comprising the steps of: A) providing a polymeric cation exchange membrane in a suitable atomic layer deposition reaction chamber under inert atmosphere; B) alternatingly introducing b1) a metal precursor or b2) an oxidant into the chamber; C) purging the chamber to re-establish an inert atmosphere; and D) repeating steps B) and C) for predetermined number of cycles until a desired thickness is obtained.

9. The method according to claim 8, wherein the metal precursor utilized in step b1) is selected from the group consisting of alkyl metals, metal alkoxides, metal halides, and alkyl amido metal compounds.

10. The method according to claim 8, wherein the oxidant utilized in step b2) is selected from the group consisting of water, ethylene glycol, oxygen, hydrogen peroxide, a hydroquinone, a diol, a triol, a primary diamine, a primary triamine, a dithiol, and a trithiol.

11. The method according to claim 9, wherein the metal precursor utilized in step b1) is the alkyl metal which is trimethylaluminum.

12. The method according to claim 11, wherein the oxidant utilized in step b2) is ethylene glycol.

13. The method according to claim 8, wherein the predetermined number of cycles is between 5 and 50.

14. An electrodialysis assembly comprising a composite membrane according to claim 1.

15. The assembly according to claim 14, operated at a voltage conductively applied to said composite membrane, said voltage produces current density of between about 5 to about 500 Am⁻² in said membrane.
